(19) United States
(12) Patent Application Publication
(10) Pub. No.: US 2023/0081407 A1
(43) Pub. Date: Mar. 16, 2023

(54) SYSTEM AND METHOD FOR INDOOR CULTIVATION AND PROCESSING OF DUCKWEED

(71) Applicant: HTL WATER SYSTEMS, INC., ROLLING HILLS ESTATES, CA (US)

(72) Inventors: TIMOTHY D. BIEHLER, SAN PEDRO, CA (US); BENJAMIN J. BRANT, EVERGREEN, CO (US); KURT EDERER, SAN PEDRO, CA (US); FRANCIS D. BERRY, ROLLING HILLS ESTATES, CA (US)

(73) Assignee: HTL WATER SYSTEMS, INC., ROLLING HILLS ESTATES, CA (US)

(21) Appl. No.: 17/447,417

(22) Filed: Sep. 10, 2021

(51) Int. Cl. A01G 9/02; A01G 27/00; A01G 9/029; A01G 7/04

(52) U.S. Cl. CPC A01G 9/023; A01G 27/00; A01G 9/029; A01G 7/045

(57) ABSTRACT

A photobioreactor system includes a growing tower tray assembly configured to utilize laminar flow to harvest a plant; a nursery subsystem configured to feed inoculum to the growing tower tray assembly; and a nutrient feeding subsystem configured to feed nutrient media to the growing tower tray assembly.

### BACKGROUND

The present invention generally relates to cultivation and processing of Lemnacaeae (aka duckweed) and, more particularly, to apparatus and methods of indoor cultivation and processing of Lemnacaeae.

The existing and future market for protein-based food and feed is enormous. Population is anticipated to grow by another 2.5 billion or more by 2040 according to the United Nations Food and Agriculture Organization. That is a lot of mouths to feed when currently one out of six lack food security or are malnourished. To supply the next 1 billion people with an average diet containing 80 grams per day of protein will require an additional 80,000 metric tons per day of protein—or 29 million metric tons per year. And, we must do this while continuing to feed the existing population.

How do we meet this demand? If the source is vegetable based, producing this amount of soy protein (in the form of tofu) would require an additional 150-million acres of suitable, irrigated, and fertilized farmland to be put into production—nearly sixteen states the size of California (Food and Agriculture Organization, 2009). If the source is animal based and accounting for the inefficiencies of moving up the food chain, the land requirement would jump to 260 million acres-almost twenty-seven states the size of California.

Fish farming is an alternative to land-based protein. However, farmed fish eat fishmeal (ground up anchovies and other small species) and the fishmeal supply is dwindling due to overfishing, climate change and pollution. Therefore, fish farmers need alternative sources of feed protein to grow the fish supply.

Animal protein sources for food ingredients are primarily from dairy milk and whey concentrates and eggs. Egg protein dominates the market with 70% of the demand. Vegetable protein sources include soy, wheat, pea, rice, potato, and canola. Soy proteins have the largest market share at 59%. Soy is also used in a variety of dairy products to increase protein content in cheese, milk, deserts, whipped toppings, yogurt, and coffee whiteners. Pea protein isolates can be as high as 85% with growing applications in meat substitutes, processed foods, soups, sauces, baked goods, snacks, nutraceuticals, and sports nutrition.

Plant-based protein is now used in meat substitutes widely marketed by Beyond Meal™ and Impossible Burger™ and others found in fast food restaurant chains and grocery stores. For example, Impossible Burger™ uses a soy-based leghemoglobin “heme” protein that is supposed to imitate the bloodiness of a beef burger. However, this alternative is genetically modified, and as with other genetic modifications, there is risk of environmental contamination and loss of control of the engineered organisms. Moreover, the food has gone to market with minimal oversight from the U.S. Food and Drug Administration. While alternative meat substitutes and even “lab grown” meat reduce the environment footprint of meat protein from livestock, there is growing concern about the nutritional value and safety of these imitations.

Certain aquatic plants, such as duckweed and micro-algae, are known for their high nutritional value, as well as their rapid growth rate. In fact, duckweed doubles its growth rate every two to three days. Due to these qualities, there is a growing interest in using such aquatic plants for various applications such as: waste-water treatment, water remediation, bio-energy production, and, more recently, high protein for food, animal, and pet feed applications. Duckweed is known to have a protein yield that may be as high as 46%. That compares to other sources of plant or animal protein that have lower yields, such as soya beans at 40% and peas at 20%.

Duckweed also has a high green pigment content and as well as being a good source of vitamins, minerals, and as many as eighteen essential amino acids. The aquatic plant is high in starch (up to 40%, which makes it ideal to be fermented into biofuels such as alcohol and biogas). It also is low in fiber (5%) and ash content, making it easy to dewater, mill and dry.

Duckweed is most-commonly grown in outdoor earthen or diked ponds or engineered raceways. These embodiments are plagued with environmental quality problems particularly when the crop is cultivated for commercial purposes and consumption by humans or livestock. While such systems are quite suitable for treating and purifying sewage, the harvested duckweed is totally unfit for human consumption-the reason primarily being the presence of intestinal microbes and virus contamination and/or heavy metal accumulation. In nature, duckweed grows in coexistence with unicellular and filamentous micro-algae. Man-made and engineered outdoor growing systems also suffer from contamination by algae, where algae species can sometimes be suppressed by the addition of certain chemicals (i.e., idioform) to kill the algae. However, this adds expense and reduces the potential to certify the duckweed crop as “organic” under U.S. Department of Agriculture regulations.

Outdoor systems can also be contaminated by airborne dust, debris, and insects. Wind is also a major factor where duckweed populations can be blown to the edges of ponds and raceways. Wind effects may be mitigated to a certain extent by installing a matrix of floating berms installed in the ponds or raceways to make smaller sections less subject to being blown around. This also adds capital expense and requires more labor to maintain the ponds or raceways and to move the floating berms during harvesting.

Outdoor growing is also impacted by climate and weather where in colder temperate regions the duckweed goes into hibernation during periods of freezing. When temperatures dip below 20° C., the duckweed can go dormant and stop growing altogether. In these colder climates, the growing season can be six months or less. In warm temperate or tropical climates, duckweed can be grown year-round. However, when water temperatures exceed 32° C., the duckweed becomes stressed, and ceases growing, or begins dying.

Outdoor growing is also very land intensive with yields varying from five to twenty tons of dry biomass per acre, depending on nutrient availability and climate. Such large land areas to grow duckweed can require extensive infrastructure with piping, valves, and pumping stations.

The harvested Lemna are difficult to separate from snails, insects, worm, protozoa, algae and bacteria. Accordingly, pond water can contain 108 coliform (with 106 fecal), 104 fecal streptococci, 300 salmonella and shigella pathogens and pathogenic viruses.

As can be seen, there is a need for improved apparatus and methods for harvesting and processing duckweed.

### SUMMARY OF THE DISCLOSURE

In one aspect of the present disclosure, a photobioreactor system comprises a growing tower tray assembly configured to utilize laminar flow to harvest a plant; a nursery subsystem configured to feed inoculum to the growing tower tray assembly; and a nutrient feeding subsystem configured to feed nutrient media to the growing tower tray assembly.

In another aspect of the present disclosure, a photobioreactor system comprises a growing tower tray assembly configured to utilize surface tension to harvest a plant; a nursery subsystem configured to feed inoculum to the growing tower tray assembly; and a nutrient feeding subsystem configured to feed nutrient media to the growing tower tray assembly.

In a further aspect of the present disclosure, a photobioreactor assembly comprises a plurality of trays stacked in a direction of gravity; and a respective conical funnel in each of the plurality of trays; wherein the respective funnels of adjacent trays are misaligned with one another in the direction of gravity.

These and other features, aspects and advantages of the present disclosure will become better understood with reference to the following drawings, description, and claims.

### BRIEF DESCRIPTION OF THE DRAWINGS

FIG. 1 is a schematic view of an exemplary embodiment of a photobioreactor (PBR) system according to the present disclosure.

FIG. 2 is a flowchart of an exemplary embodiment of a PBR control system according to the present disclosure.

FIG. 3. is a perspective view of an exemplary embodiment of a PBR assembly according to the present disclosure.

FIG. 4. is a front elevational view of an exemplary embodiment of a PRB assembly according to the present disclosure.

FIG. 5 is a side elevational view of an exemplary embodiment of a PRB assembly according to the present disclosure.

FIG. 6. is a perspective view of an exemplary embodiment of a PBR frame according to the present disclosure.

FIG. 7 is a perspective view of an exemplary embodiment of a PBR module according to the present disclosure.

FIG. 8 is a top, perspective view of an exemplary embodiment of a PBR tray according to the present disclosure.

FIG. 9 is a bottom, perspective view of an exemplary embodiment of a PBR tray according to the present disclosure.

FIG. 10 is an exploded view of an exemplary embodiment of a stack of PBR trays according to the present disclosure.

### DETAILED DESCRIPTION OF THE DISCLOSURE

The following detailed description is of the best currently contemplated modes of carrying out the disclosure. The description is not to be taken in a limiting sense, but it is made merely for the purpose of illustrating the general principles of the disclosure, since the scope of the disclosure is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The technical problems to be solved include environmental quality problems, contamination, uncontrollable climate and weather, and land requirements from outdoor growing systems for duckweed. The present disclosure solves the foregoing problems by providing a closed-loop system and method for the indoor, vertical cultivation and harvesting of duckweed by employing a stacked photobioreactor (PBR) assembly that is configured to utilize gravity, surface tension, and/or laminar flow. The present disclosure ensures quality and a high yield that can be produced on a 24/7 year-round basis.

The present disclosure of cultivating duckweed can use certifiable organic methods as a valuable and nutritious plant-based protein-rich food source for humans and animals containing a high level of protein (e.g., minimum of 36%), starch and fiber.

The present disclosure of growing duckweed can generally utilize an indoor controlled environment aquaculture system designed as an enclosed photobioreactor (PBR) comprising a plurality of vertically stacked flat trays mounted on racks with the racks situated in parallel rows within a building enclosure or greenhouse structure. The duckweed can be grown in a shallow depth (e.g., 3″ to 6″) of nutrient rich media of water (i.e., culture media) that can be recirculated in each tray.

In the present disclosure, the duckweed can be allowed to grow continuously until it achieves a maximum density of biomass covering the entire tray. As a small flowering aquatic plant, the duckweed floats on top of a culture medium mainly of clean water in multi-tray modules in a controlled environment. At prescribed time internals, the water level in the first tray(s) at the top of a growing tray tower can be raised by a pump at the bottom of the tower whereby the water can begin to spill over a siphon funnel positioned at one end of the tray. Thus, a natural suction force can be created that pulls the duckweed to a siphon where, by gravity, the water and duckweed can be discharged in a cascading manner from the top-most tray to the lowest most tray before exiting the system.

A siphon funnel may be in the center at one end of each growing tray, according to the present disclosure. The location of each siphon funnel can alternate between growing trays, with one on the right-hand side and the tray below on the left-hand side. The duckweed can be thereby collected, de-watered and harvested.

In this disclosure, de-watering can be achieved by pumping the collected duckweed up to an inclined gravity separator containing a certain sized wire mesh screen, angled at a slope, that permits the water to drain (decant) through the screen. This may allow the de-watered duckweed to fall by gravity down the face of the screen to a collection bin below the separator. The remaining water collected from the separator may then be recycled to the top-most tray by means of a pump. Prior to recycling of the water, the discharge water may flow to a treatment system where it can be purified and disinfected, optionally using a combination of micro-filtration, electro-coagulation (EC) and/or reverse osmosis (RO).

After treatment, according to the present disclosure, the water can flow into a mixing tank where a formulation of certified organic fertilizer is blended and that contains nitrogen (N), phosphorous (P), and potassium (K) macro-nutrients together with micro-nutrients (Mg, Ca, Fe, etc.) enzymes and microbes; or as an alternative-fish wastewater-which contains many of the same macro and micro-nutrients. The blended organic fertilizer formulation can be added to the liquid growing media for feeding the remaining unharvested duckweed. To enhance the growth of duckweed, dilute amounts of carbon dioxide (CO₂) and oxygen (O₂) gas can be bubbled into the liquid growing media.

The present disclosure may provide an alternative to drying and processing the duckweed by means of milling to separate the bound-up interstitial water in the duckweed cells where the recovered water contains the nutrients (N, P, K) that may be recycled back to the growing trays as fertilizer for further processing of the dried duckweed.

According to the present disclosure, a method for drying the collected raw duckweed can be by means of solar energy, radiant, infra-red or waste heat. The dried duckweed may be packaged for shipment and for further processing, such as biorefining it into a concentrated protein meal and bioethanol fuel as a co-product. Or, in the alternative, it may be milled (i.e., micronized) into powder for use as an additive or ingredient in functional foods for human consumption or pelletized into a dense animal feed for livestock or fish. The dried, raw unprocessed duckweed may be packaged for direct use as a protein rich plant-based food supplement for consumption by humans, livestock, or fish.

The controlled environmental structure, according to the present disclosure, can provide sufficient space for the vertical racks of trays together with the necessary mechanical fixtures of piping, valves, pumps, heating, cooling, and ventilation systems along with the necessary electrical circuitry with switches and breaker panels to provide for safely operating the PBR system and the enclosure where the PBR system is contained. Utilizing this mechanical and electrical equipment, the water culture medium can be circulated by a pump from the end of the lowest level of trays to a plurality of the topmost trays where the culture medium flows by gravity to an oppositely oriented tray directly below. This may not only facilitate the process of harvesting, but it may aerate the medium and distribute the formulation of organic nutrients and bio-stimulants throughout the vertically stacked trays.

The PBR system, in the present disclosure, can utilize artificial lighting consisting of energy efficient LED lamps affixed to the bottom of each growing tray that is suspended above said growing tray where light from the LED lamps illuminates directly onto the surface below where the duckweed plants are growing. The LED lamps may emit specific wave lengths of light (i.e., photons) that may vary from time to time in frequency to optimize the photosynthetic growth rate of the duckweed.

In the present disclosure, energy to operate the PBR system and building enclosure may be supplied from the sun using photovoltaic or solar thermal systems or, as an option, from biogas, synfuel, or ethanol biofuels to generate power, heat and recover waste heat and CO₂.

The present disclosure also provides a computer-based automation system to provide for both centralized and local control of all operations of the PBR system and building enclosure with the objective to optimize the performance, efficiency, optimization and maintenance of all utility, process, environmental and administrative functions.

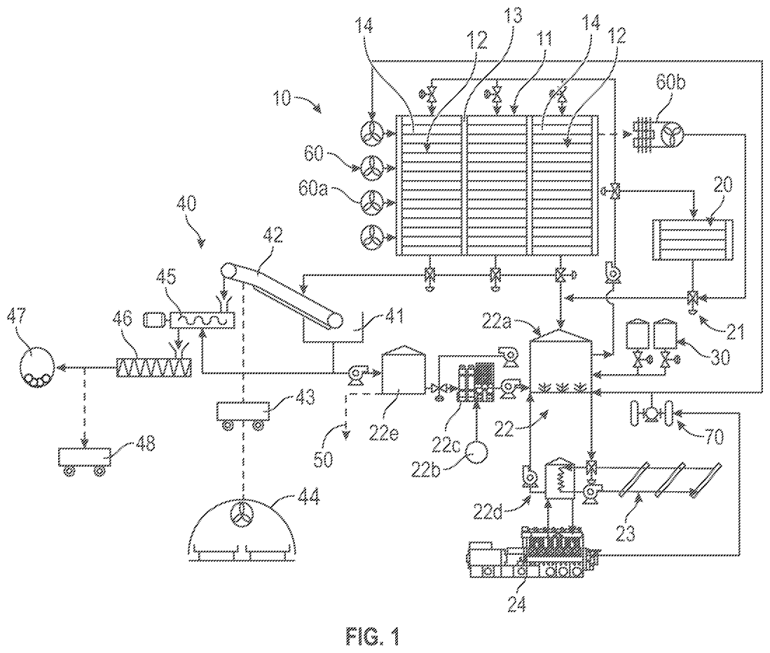

In FIG. 1, a photobioreactor (PBR) or growing system 10 is schematically depicted according to an embodiment of the present disclosure. In embodiments, the PBR system 10 may incorporate for aquatic duckweed plants growing and harvesting processes in a semi-continuous batch mode that takes place in a controlled indoor environment, as further described below. In embodiments, the PBR system 10 may completely or partially reside in an indoor environment. In embodiments, the indoor environment may be a controlled environment for factors such as temperature and humidity.

In embodiments, the PBR system 10 may include a photobioreactor (PBR) or growing tower tray assembly 11 that can hold aquatic plants and growing media. In embodiments, the PBR assembly 11 may be configured to operate on the bases of gravity, surface tension, and/or laminar flow as further described below.

In embodiments, the PBR assembly 11 may include one or more photobioreactor (PBR) or growing tower tray modules 12, arranged in a modular fashion, as further described below. One or more of the PBR modules 12 may include a growing tower tray frame 13 that can support one or more photobioreactor (PBR) or growing tower trays 14, as further described below. In embodiments, one or more of the PBR trays 14 may hold growing duckweed plants and growing media wherein the PBR tray(s) 14 can be configured to harvest the duckweed plants based on gravity, surface tension, and/or laminar flow as further described below.

In embodiments, the PBR system 10 may further include an aquatic plant nursery subsystem 20. The nursery subsystem 20 may be configured to seed/feed the PBR system 10 with inoculum (i.e., baby duckweed plants) and, more specifically, configured to seed/feed the growing tower tray assembly 11 and the growing tower trays 14 therein with inoculum, according to embodiments. In embodiments, the nursery subsystem 20 may convey inoculum to the PBR assembly 11 via a piping subsystem 21 and a water subsystem 22 further described below.

According to embodiments, the nursery subsystem 20 can maintain duckweed seedlings of a strain(s) chosen by the user. In embodiments, the nursery subsystem 20 may be constructed similarly to that of the PBR assembly 11. In embodiments of the nursery subsystem 20, the number of modules 12, frames 13 and/or trays 14 may be the same or different than that in the PBR assembly 11.

In embodiments, the water subsystem 22 may be configured to supply water to the PBR or growing tower tray assembly 11. In embodiments, the water subsystem 22 may include a mixing tank 22a which can be configured to receive inoculum from the nursery subsystem 20. The mixing tank 22a may also be configured to receive recycled water/growing media from the PBR assembly 11, in embodiments.

In embodiments, the water subsystem 22 may further include a water supply 22b and a water treatment/filtration unit 22c. In embodiments, the water supply 22b may be from a well or municipality. Thereby, fresh water can be supplied from the water supply 22b to the treatment/filtration unit 22, and then to the mixing tank 22a. In embodiments, water from the supply 22b may be supplied on a regular basis to replace water lost in the PBR assembly 11 due to evapotranspiration and from the carryover of extra-cellular water during the harvesting process using the screen conveyor described below.

In embodiments, the treatment/filtration unit 22c may be configured to adjust pH, adjust dissolved oxygen, adjust total dissolved solids in the water, as examples. In embodiments, the treatment/filtration unit 22c may employ micron filters, reverse osmosis, ozonation, UV lights, and/or electrocoagulation. According to embodiments, the treatment/filtration unit 22c may minimize or eliminate pesticides, pathogens and/or algae.

According to embodiments, the water subsystem 22 may also include a water heating unit 22d, which may be powered by a solar unit 23 and/or a generator unit 24. For example, the solar unit 23 may employ flat panels and/or compound parabolic panels to provide a renewable energy source of heating the PBR system 10 and/or indoor environment. In another example, the generator unit 24 may be configured as a co-generation unit to supply both heat and power for the PBR system 10 and/or indoor environment. In other examples, the generator unit 24 may be natural gas or biogas fueled.

The water subsystem 22 may furthermore include a return water tank 22e, according to embodiments. In embodiments, the water tank 22e may receive and temporarily store water from a plant receiving unit 41 and/or an auger 45 described below. Water collected in the water tank 22e may either be discharged to an outside environment 50 or directed to the filtration unit 22c, according to embodiments.

Still referring to FIG. 1, the PBR system 10 may include a nutrient feeding or fertigation subsystem 30 that can be configured to feed to the PBR or growing tower tray assembly 11. In embodiments, the nutrient feeding subsystem 30 may feed to the PBR assembly 30 via the water subsystem 22 and, specifically, via the mixing tank 22a, in embodiments. The nutrient feeding subsystem 30 may contain certified organic fertilizers for blending into a growing media. In embodiments, the certified organic fertilizers may contain specific amounts of nitrogen, phosphorous, and/or potassium macro-nutrients together with micro-nutrients (Mg, Ca, Fe, etc.), enzymes and microbes; or as an alternative-fish wastewater-which contains many of the same macro and micro-nutrients.

In embodiments, the mixing tank 22a may feed nutrient/growing media, via the piping subsystem 21, to the PBR assembly 11. In the PBR assembly 11, the plants may utilize the nutrient/growing media for growth. Unused nutrient/growing media in the PBR assembly 11 may be discharged from the PBR assembly 11 at a lower of bottom area thereof, according to embodiments. The discharged media may be sent, via the piping subsystem 21, to the mixing tank 22a where the discharged media can again be mixed with nutrients and pumped back to the PBR assembly 11.

In embodiments, the PBR system 10 may include a plant processing subsystem 40. In embodiments, the processing subsystem 40 may be configured to receive grown plants from the PBR assembly 11, de-water the plants, dry the plants, mill the plants, and/or micronize the plants.

The processing subsystem 40 may include a plant receiving tank 41 which can be configured to receive, via the piping subsystem 21, grown plants from the PBR assembly 11, according to embodiments.

For purposes of illustration, and not by way of limitation, the receiving tank 41 may be a six by eight-foot concrete pit, four feet deep, that is tapered on one end narrowing down to three and one-half feet that serves as a channel for a conveyor unit 41 described below.

The processing subsystem 40 may further include the conveyor unit 41 operatively adjacent the receiving tank 41. As an example, and not as a limitation, the conveyor unit 41 may be about twenty feet in length, and about three and one-half feet in width. The conveyor unit 41 may have a tail stock mechanism which, in embodiments, is positioned in or near the channel of the receiving tank 41. In embodiments, the tail mechanism can be submerged into the channel and receiving tank 41. This can be a collection point where the mature duckweed is harvested and de-watered for further processing.

In embodiments, the conveyor unit 41 may have a mesh (e.g., about a three-millimeter pore size) that can permit extra-cellular water to drain off as a conveyor belt conveys de-watered duckweed up at angle. At a top of the conveyor belt, a head stock mechanism can enable the plant to fall off the belt by gravity. Just below the head stock, a bar or scraper (e.g., made of rubber or plastic) can be positioned perpendicular to a width of the belt whereby excess plant can be scrapped off as the belt begins its return to the tail stock, thus completing its circular circuit.

The processing subsystem 40 may additionally include a first portable collection bin 43. The first collection bin 43 may be positioned below the scrapper of the conveyor unit 41 to receive the harvested and de-watered plants. Once the first collection bin 43 is full, in embodiments, it may be transported to a first drying unit 44 of the processing subsystem 40 for drying of the plants. The drying unit 44 may, in embodiments, include flat beds in a hoop-type greenhouse with fan assisted air drying.

The processing subsystem 40 may further include an auger 45. In embodiments, using the auger 45 may be an alternative or adjunct to using the collection bin 43. In embodiments, the auger 45 may be positioned below the head stock of the conveyor unit 41. Thereby, the auger 45 may receive de-watered plants from the conveyor unit 41 and convey the same to a second drying unit 46 of the processing subsystem 40.

In embodiments, the second drying unit 46 may be thermal based. In embodiments, the second drying unit 46 may use far-infrared, electric radiant, or gas heating means. In embodiments, the second drying unit 46 may be positioned below the head stock of the conveyor unit 41.

The processing subsystem 40 may furthermore include a milling/micronizing unit 47. The unit 47 may perform either or both of milling and micronizing of the dried plant from the second drying unit 46. Thereafter, the milled/micronized plant may be sent to packaging and/or market.

In the alternative and/or as an adjunct to the milling/micronizing unit 47, the dried plant from the second drying unit 46 may be sent to a second portable collection bin 48 for transportation to packaging and/or market.

The PBR system 11 may include a ventilation subsystem 60 that may provide and control humidity and fresh air in the indoor environment and/or PBR assembly 11. In embodiments, the ventilation subsystem may include one or more fans 60a. The one or more fans 60a can be disposed at one side of the PBR assembly 11, according to embodiments. The one or more fans 60a can utilize a combination of outside air and return air. In embodiments, the one or more fans 60a can be configured to direct air to and through one or more PBR modules 12 and, thereby, across one or more PBR trays 14.

In embodiments, the ventilation subsystem 60 may also include an exhaust fan/condenser 60b which may be disposed at a side of the PBR assembly 11 which is opposite the side where the fans 60a are located. The exhaust fan/condenser 60b may be configured to recover heat and water lost due to evapotranspiration. The exhaust fan/condenser 60b may exhaust air from the PBR assembly 11 and condense water vapor in such exhaust air, according to embodiments. Water can be recovered from moisture in the exhaust air by employing a chilled water coil(s) whereby the exhaust air can be cooled as it flows past the coil. Water may condense on the cooling coil(s) and exit into a drain pan below that may contain distilled and purified water. The distilled and purified water may then be directed to the mixing tank 22a.

In embodiments, the PBR system 11 may additionally include an aeration unit 70. The aeration unit 70 may be configured to inject CO₂ gas, via the piping subsystem 21, into the mixing tank 22a. Alternatively or as an adjunct, the CO₂ gas may be injected into the indoor controlled environment. In embodiments, the CO₂ gas may be injected by a low, cubic feet per minute compressor and fine bubble diffusers. In embodiments, the CO₂ gas may be injected at about 800 mg/L (ppm). According to embodiments, the source of the CO₂ gas may be waste exhaust from the generator 24 and which exhaust has been filtered.

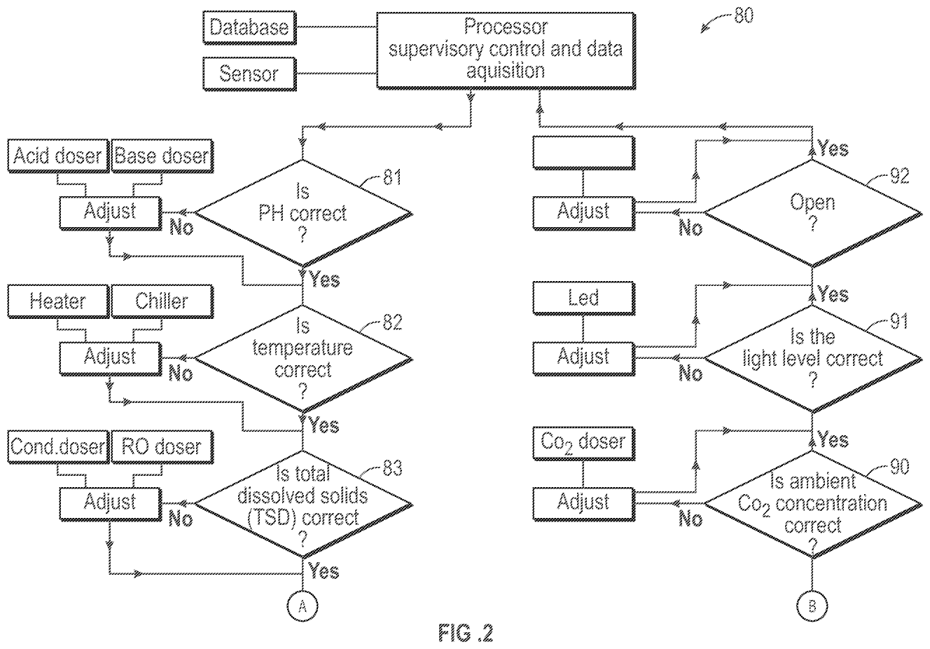

In FIG. 2, a control system or logic 80 is schematically depicted. In embodiments, the control system 80 may control one or more of the subsystems in the PBR system 10. The control system 80 may be implemented via a processor(s), a database(s), and appropriate sensors throughout the PBR system 10. For example, a sensor may sense an operating characteristic of the PBR system 10 and/or an environmental characteristic within the indoor environment of the PBR system 10.

Although the following is described in a numerical sequence, no particular order of the following is intended.

At block 81, a pH of the water/growing media in the PBR system 10 may be checked for correctness. If not correct, the pH can be adjusted via the water subsystem 22.

At block 82, a temperature of the indoor environment may be checked for correctness. If not correct, the temperature can be adjusted via the ventilation subsystem 60.

At block 83, a total dissolved solids (TDS) in the water/growing media may be checked for correctness. If not correct, the TDS can be adjusted via the plant nursery subsystem 20 and/or nutrient feeding subsystem 30 and/or processing subsystem 40.

At block 84, a dissolved oxygen in the water/growing media may be checked for correctness. If not correct, the dissolved oxygen can be adjusted via the aeration unit 70.

At block 85, a nutrient level in the water/growing media may be checked for correctness. If not correct, the nutrient level can be adjusted via the nutrient feeding subsystem 30.

At block 86, a water level in the PBR assembly 11 may be checked for correctness. If not correct, the water level can be adjusted via the water subsystem 22.

At block 87, a water flow in the PBR assembly 11 may be checked for correctness. If not correct, the water flow can be adjusted via the water subsystem 22.

At block 88, an air temperature in the indoor environment may be checked for correctness. If not correct, the air temperature can be adjusted via the ventilation subsystem 60.

At block 89, a relative humidity in the indoor environment may be checked for correctness. If not correct, the relative humidity can be adjusted via the ventilation subsystem 60.

At block 90, an ambient CO₂ concentration in the indoor environment may be checked for correctness. If not correct, the CO₂ concentration can be adjusted via the aeration unit 70.

At block 91, a light level in the PBR assembly 11 may be checked for correctness. If not correct, the light level can be adjusted via the PBR assembly 11.

At block 92, other system and/or indoor characteristics may be checked and corrected.

In embodiments, the control system 80 may implement one or more of the following characteristics:

(a) a high density of duckweed maintained in the growing trays at all times with more than 200 to 400 g fresh weight;

(b) replacing evaporated water of no more than 5% of water growing medium per week and replacing it with clean, filtered water;

(c) adding missing elements to balance the nutrients consumed by the duckweed, based upon analysis, with the major element being ammonium nitrogen; its application can be measured by pH drop to maintain an optimum pH level of 6.5;

(d) utilizing an organic nutrient complex with (% by weight): nitrate N 4.5; ammonia N 3.0; P₂O₅ 3.2 with half in polyphosphates; K₁O 6.5; and trace elements. It is preferred that trace elements total 3.0% containing per liter: 6 g Fe, 1 g Mn, 2 g Zn, 0.4 g Cu, 0.03 g Mo.

(e) maintaining a water temperature of 20 to 25° C.;

(f) using nutrients that are pure organic compounds (i.e., organic acids and salts, sugars) or digestate from anaerobic digestion of livestock manures that has undergone thermophilic fermentation to kill viruses and bacteria;

(g) removing filamentous algal material and other particles larger than 10 cm during water recirculation; and,

(h) maintaining light intensities at 150 uE/M²S−1 which are more fully absorbed during photosynthesis.

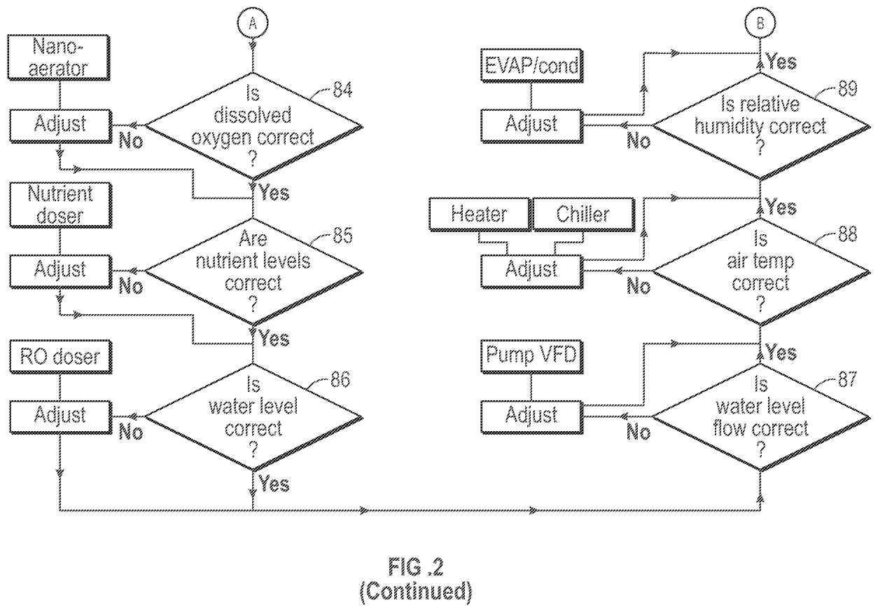

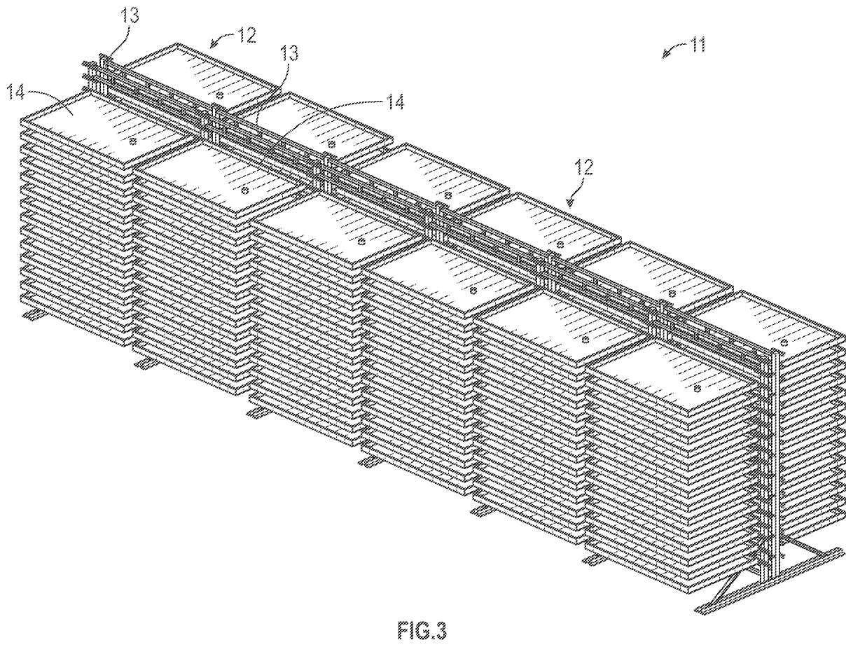

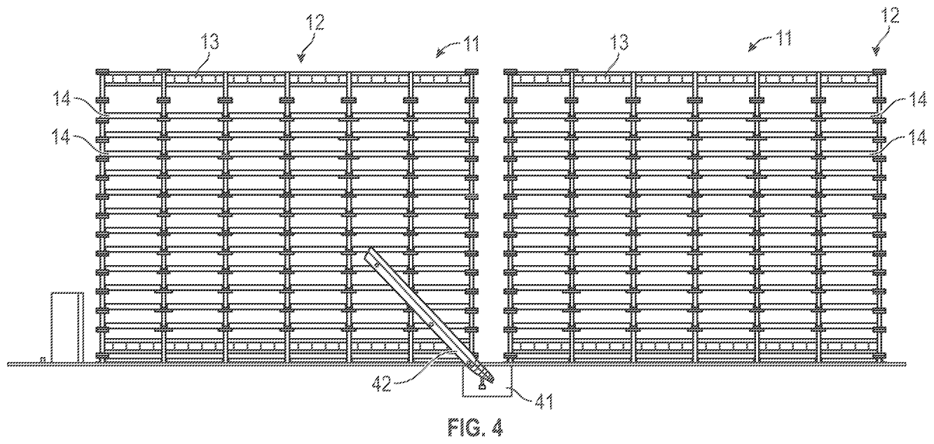

In FIGS. 3-5, a PBR or growing tower tray assembly 11 according to an embodiment is depicted. In embodiments, the PBR assembly 11 can be configured to utilize gravity, surface tension, and/or laminar flow to harvest a plant. The PBR assembly 11 may include one or more PBR or growing tower tray modules 12. One or more PBR modules 12 may include a PBR or growing tower tray frame 13 which may support one or more PBR or growing tower trays 14. In embodiments, the trays 14 can be in a vertically stacked configuration (i.e., stacked in a direction of gravity). In embodiments, the trays 14 can be in an alternating stacked configuration. In embodiments, one or more trays 14 can be configured to utilize gravity, surface tension, and/or laminar flow to harvest a plant.

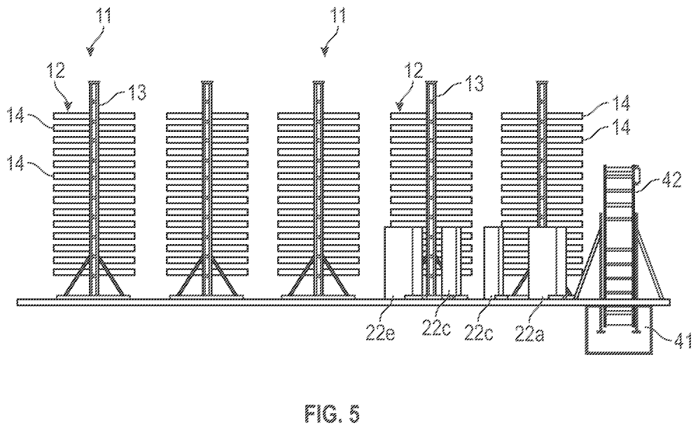

In FIG. 6, a PBR or growing tower tray frame 13 according to an embodiment is depicted. The frame 13 may include one or more frame units 13a which may be arranged together in a modular fashion.

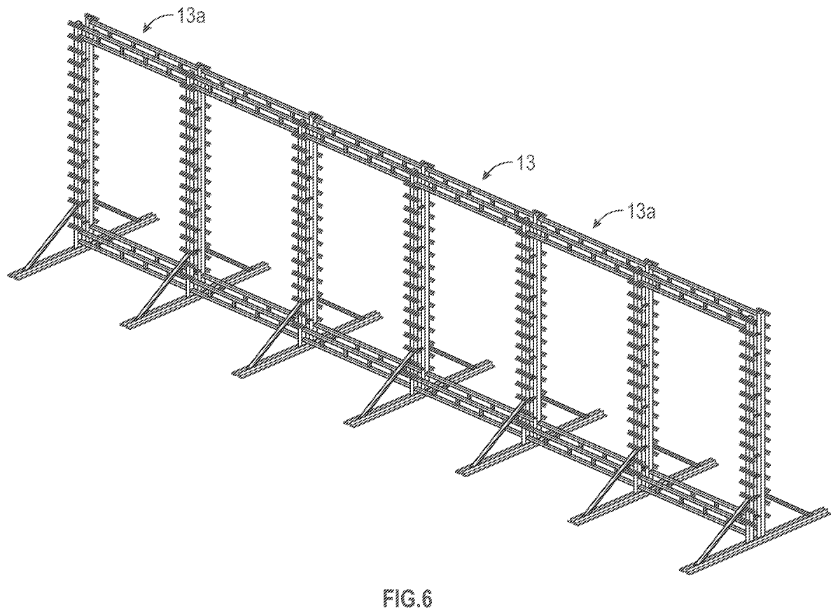

In FIG. 7, a frame unit 13a according to an exemplary embodiment is depicted. The frame unit 13a may include a pair of horizontal supports 13a-1, a pair of vertical supports 13a-2, and a pair of stands 13a-3, according to embodiments. One or both vertical supports 13a-2 may include one or more tray attachment points 13a-4 configured to attach to an edge/corner/side of a tray 14, in embodiments. Also, one or both vertical supports 13a-2 may include one or more suspension attachment points 13a-5 configured to attach a flexible suspension material, such as wire, to an edge/corner/side of a tray 14.

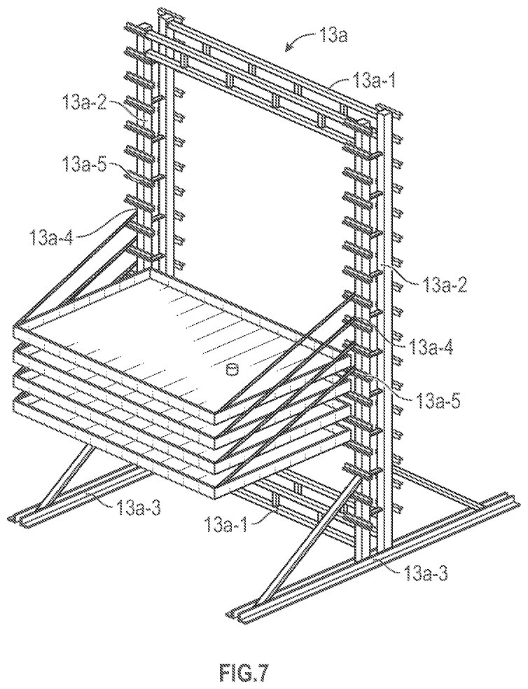

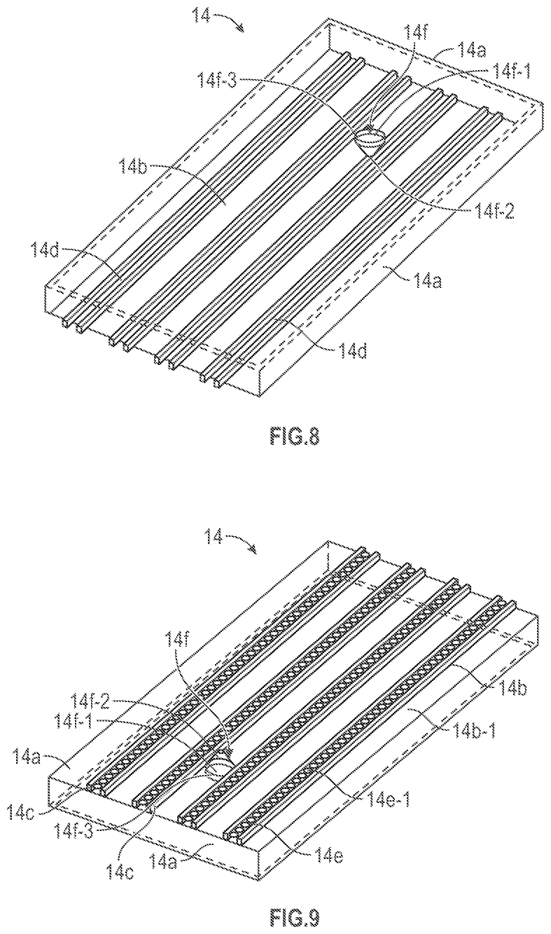

In FIGS. 8 and 9, a PBR or growing tower tray 14 according to an embodiment of the present disclosure is depicted in a top and bottom view, respectively. The tray 14 can be part of the vertical PBR assembly 11 for continuously growing and harvesting aquatic duckweed plants in a controlled indoor environment. In embodiments, the tray 14 may be configured to hold a culture medium of organic nutrients, bio-stimulants, and diffused CO₂ gas. The tray 14 can be further configured to emit light for indoor plant photosynthesis. These embodiments can increase the growth rate and quality of duckweed plants, as well as increase the yield of protein with targeted amino acid profiles.

In embodiments, one or more of the trays 14 may be generally rectangular in shape, although other shapes are contemplated. One or more of the trays 14 may have four upstanding walls 14a around a perimeter thereof, and it may have a base 14b from which the walls 14a can extend. In embodiments, the base 14b may be planar and the walls 14a may extend perpendicularly therefrom.

The two opposing shorter walls 14a in length may each have a reinforced molded tab with a pair of respective holes for purposes of attachment to one frame unit 13a. One pair of the holes on one of the short walls 14a permit each tray 14 to be attached, such as by locking bolts, to a structural column in the frame unit 13a (FIG. 7), for example at attachment points 13a-4. Another pair of holes on the other short wall 14a (i.e., the suspended end of the tray 14) may have adjustable eyebolts that can be attached to high tinsel strength braded stainless-steel wire which can also be affixed to a structural column of the frame unit 13a, for example at attachment points 13a-5.

Accordingly, in embodiments, the long side of the trays 14 are cantilevered (FIG. 7) out from the frame unit 13a with the inside facing edge of the tray 14 bolted to horizontal brackets 13a-4 that extend out on either side of a center support structure 13a-2 of the frame unit 13a. The horizontal brackets can be used to bolt two trays 14 side-by-side at the inside corner of the tray wherein a row of trays is connected to form a growth module. Thereby, virtually all the live weight of the tray 14 containing water and floating duckweed is structurally suspended to the center support structure. Each tray 14 can be level horizontally when installed.

For purposes of illustration, and not by way of limitation, the growing tower tray 14 may be able to hold about 30 to 50 gallons of growing media, and it may have a volume capacity of about 4 to 8 cubic feet. The base 14b may have a rectangular dimension of about 3 to 6 feet×about 6 to 8 feet, and the walls 14a may have a height of about 3 to 8 inches.

According to embodiments, an exterior surface 14b-1 of the base 14b may be configured with lengthwise extending ribs 14c, such as in two to four sets, with each set having two parallel ribs 14c which form a channel 14d therebetween.

The tray 14 may further have, in embodiments, one or more LED lighting systems 14e to simulate outdoor sunlight necessary for plant photosynthesis. In embodiments, one or more of the LED lighting systems 14e may be in the form of a strip of LED lights 14e-1. One or more of the LED lighting systems 14e may be disposed on the exterior surface 14b-1 of the base 14b, and which surface 14b-1 faces towards an exterior of the growing tower tray 10. The LED lighting systems 14e may be adhered to the exterior base surface 14b-1 by Velcro™ for example.

In embodiments, one or more LED lighting systems 14e may be disposed between two ribs 14c in one or more pairs of ribs 14c. In embodiments, one or more of the LED lighting systems 14e may extend in a lengthwise direction and be disposed in one or more of the channels 14d. Accordingly, one or more of the LED lighting systems 14e may emit light away from (as opposed to inward of) the tray 14. Electrical lines may connect the ends of each LED lighting system 14e, for example, by using snap-together plugs.

For purposes of illustration, and not by way of limitation, one or more of the LED lighting systems 14e may have a wavelength of about 350 to 780 nm. Based on an exemplary three watts per square foot of growing area in a single growing tower tray 14, the LED lighting systems 14e in a single tray 14 may provide about 900 watts to 1200 watts.

According to embodiments, the growing tray 14 may further have a siphoning funnel 14f. In embodiments, the siphoning funnel 14f may be configured to enable a plant to flow therein by gravity, surface tension, and/or laminar flow for purposes of harvesting the plant.

In embodiments, the siphoning funnel 14f may be a hole 14f-1 in the base 14b. For purposes of illustration only, the siphoning funnel 14f may have a diameter of about 2 inches to 4 inches. In embodiments, the siphoning funnel 14f may be a cone 14f-2, which may be wider at one end (i.e., the top or interior of the tray 14) and narrower at the other end (i.e., the bottom or exterior of the tray 14). A pipe 14f-3 may be mounted in the hole at the top of the siphoning funnel 14f and the pipe 14f-3 can thereby extend above the base 14b. The siphoning funnel 14f can be sealed by an O-ring where it is mounted to the base 14b.

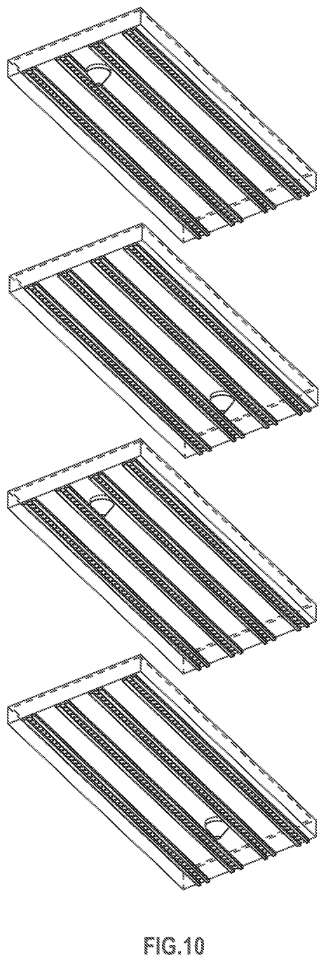

According to embodiments, the growing trays 14 can be in a vertically stacked configuration (FIG. 3-5). The trays 14 can be in an alternating stacked configuration, in embodiments. In the foregoing configurations, according to embodiments, the respective funnels 14f in the trays 14 may have an alternating configuration, such as from an uppermost tray 14 to a bottommost tray 14. (FIG. 10)

In embodiments, a funnel 14f in one tray may be oriented at the left side of the frame unit 13a and the next tray 14 below may have its respective funnel 14f oriented at the right side of the frame unit 13a, and so on. Accordingly, it may be said that the respective funnels 14f in adjacent trays 14 are misaligned with one another in a vertical direction (i.e., a direction of gravity).

In an embodiment, the growing tray 14 may operate in the following fashion. A suitable amount of inoculum (i.e., baby duckweed plants) and growing media is placed in the growing tray 14. As the duckweed plants grow, the total volume of liquid and biomass in the growing tray 14 grows. Alternatively, or as an adjunct, water and/or growing media may be pumped into a tray 14, such as the uppermost tray to increase a total volume in the tray.

In embodiments, a surface tension can be created until the level of liquid/plant exceeds the rim of the siphoning funnel 14f, such as about 1/32″ above the rim. The surface tension may break and the duckweed can be syphoned off the surface of the liquid growing media. This may create a laminar flow phenomenon that pulls the aquatic plant into the syphoning funnel 14f. The plant can fall to another tray 14 below, and the above process repeats until reaching a bottom-most tray 14.

In embodiments, the siphoning funnel 14f may be regulated on a timed cycle. Thereby, the growing tray 14 can be filled to a required level to facilitate the natural siphoning or skimming effect of collecting a certain amount of duckweed by laminar flow that is discharged by gravity into the tray 14 below it. As the discharge of each tray 14 cascades into the one below, the timed duration of this siphoning event can be regulated to control the amount of duckweed that is harvested each day.

In embodiments, at or near the discharge from the PBR assembly 11, the piping subsystem 21 may include a main supply, return pipes, and manifold headers with smaller pipes to feed and discharge each PBR module 12. The main supply pipe can serve as the manifold header where small pipes can be attached to the main supply pipe to feed growing media containing duckweed at a top tray 14 mounted on each PBR module 12. The main feeder pipe can run the length of the modules 12 with smaller pipes tangential to the main feeder pipes to distribute the growing media to each of the top trays 14. A manifold of smaller discharge pipes at the bottom of each level of growing trays that run the length of each row of towers where the outlet of the last tray on the bottom feeds the main return pipe.

As can be appreciated from the above, in embodiments, the overall recirculating and harvesting processes embodied in the PBR system 10 can operate in a semi-continuous batch mode. In embodiments, not more than about 30% of the mature duckweed is harvested each day.

In embodiments, a total protein content of duckweeds grown according to the present disclosure can be between about 30% and 46% per dry weight for the different lemnaecea species.

It should be understood, of course, that the foregoing relates to exemplary embodiments of the invention and that modifications may be made without departing from the scope of the disclosure as set forth in the following claims.

We claim:

1. A photobioreactor system, comprises:
a growing tower tray assembly configured to utilize laminar flow to harvest a plant;
a nursery subsystem configured to feed inoculum to the growing tower tray assembly; and
a nutrient feeding subsystem configured to feed nutrient media to the growing tower tray assembly.

2. The system of claim 1, wherein the growing tower tray assembly is further configured to utilize gravity to harvest the plant.

3. The system of claim 1, wherein the growing tower tray assembly is further configured to utilize surface tension to harvest the plant.

4. The system of claim 1, wherein the growing tower tray assembly includes a plurality of trays in a vertically stacked configuration.

5. The system of claim 1, wherein the growing tower tray assembly includes a plurality of trays in an alternating stacked configuration.

6. The system of claim 1, further comprising:
a ventilation subsystem configured to supply air to the growing tower tray assembly.

7. The system of claim 1, further comprising:
a water subsystem configured to supply water to the growing tower tray assembly.

8. The system of claim 1, further comprising:
a processing subsystem configured to dry plant from the growing tower tray assembly.

9. A photobioreactor system, comprises:
a growing tower tray assembly configured to utilize surface tension to harvest a plant;
a nursery subsystem configured to feed inoculum to the growing tower tray assembly; and
a nutrient feeding subsystem configured to feed nutrient media to the growing tower tray assembly.

10. The system of claim 9, wherein the growing tower tray assembly is further configured to utilize laminar flow to harvest the plant.

11. The system of claim 9, wherein the growing tower tray assembly is further configured to utilize gravity to harvest the plant.

12. The system of claim 9, wherein the growing tower tray assembly includes a plurality of trays in a vertically stacked configuration.

13. The system of claim 9, wherein the growing tower tray assembly includes a plurality of trays in an alternating stacked configuration.

14. The system of claim 9, wherein the growing tower tray assembly includes a plurality of growing tower tray modules.

15. A growing tower tray assembly, comprises:
a plurality of trays stacked in a direction of gravity; and
a respective conical funnel in each of the plurality of trays;
wherein the respective funnels of adjacent trays are misaligned with one another in the direction of gravity.

16. The assembly of claim 15, wherein at least one of the respective funnels is configured to enable a plant to flow therein by laminar flow.

17. The assembly of claim 15, wherein at least one of the respective funnels is configured to enable a plant to flow therein by a break in surface tension.

18. The assembly of claim 15, wherein at least one of the respective funnels is configured to enable a plant to flow therein by gravity.

19. The assembly of claim 15, wherein the plurality of trays is configured to be cantilevered to a frame.

20. The assembly of claim 15, the plurality of trays includes an LED lighting system.
